(19) United States
(12) Patent Application Publication
(10) Pub. No.: US 2026/0052154 A1
(43) Pub. Date: Feb. 19, 2026

(54) DYNAMIC ROLE BASED ACCESS CONTROL (RBAC)

(71) Applicant: INTERNATIONAL BUSINESS MACHINES CORPORATION, Armonk, NY (US)

(72) Inventors: Ying Mo, Beijing (CN); Rui Liu, Beijing (CN); Yue Chen, Beijing (CN); Ya Xiao, Beijing (CN); Hu Wang, Beijing (CN)

(21) Appl. No.: 18/807,194

(22) Filed: Aug. 16, 2024

(51) Int. Cl. H04L 9/40

(52) U.S. Cl. CPC H04L 63/105

(57) ABSTRACT

Embodiments receive a plurality of application workloads from an external application; monitor the plurality of application workloads for at least one failed audit event; generate a role based access control (RBAC) request from the at least one failed audit event; update at least one RBAC rule based on the RBAC request; determine that minimum necessary permission are achieved in response to the RBAC request and the updated at least one RBAC rule; and re-run the application workloads in response to a determination that the minimum necessary permissions are achieved.

### BACKGROUND

Aspects of the present invention relate generally to dynamic role based access control (RBAC).

Applications have become increasingly complex and involve many resources and services. In particular, developers manage the complex applications, resources, and services to have an overall view of the applications.

### SUMMARY

In a first aspect of the invention, there is a computer-implemented method including: receiving, by a processor set, a plurality of application workloads from an external application; monitoring, by the processor set, the plurality of application workloads for at least one failed audit event; generating, by the processor set, a role based access control (RBAC) request from the at least one failed audit event; updating, by the processor set, at least one RBAC rule based on the RBAC request; determining, by the processor set, that minimum necessary permissions are achieved in response to the RBAC request and the updated at least one RBAC rule; and re-running, by the processor set, the application workloads in response to a determination that the minimum necessary permissions are achieved.

In another aspect of the invention, there is a computer program product including one or more computer readable storage media having program instructions collectively stored on the one or more computer readable storage media. The program instructions are executable to: receive a plurality of application workloads from an external application; monitor the plurality of application workloads for at least one failed audit event; generate a role based access control (RBAC) request from the at least one failed audit event; automatically approve the RBAC request based on a machine learning model which is trained based on historical RBAC requests from an external application; update at least one RBAC rule in response to automatically approving of the RBAC request; determine that minimum necessary permissions are achieved in response to the approved RBAC request and the updated at least one RBAC rule; and re-run the application workloads in response to a determination that the minimum necessary permissions are achieved.

In another aspect of the invention, there is a system including a processor set, one or more computer readable storage media, and program instructions collectively stored on the one or more computer readable storage media. The program instructions are executable to: receive a plurality of application workloads and a plurality of historical role based access control (RBAC) requests from an external application; monitor the plurality of application workloads for at least one failed audit event; generate a RBAC request from the at least one failed audit event; train a machine learning model based on the received historical RBAC requests; automatically approve the RBAC request based on the trained machine learning model; update at least one RBAC rule in response to automatically approving of the RBAC request; determine that minimum necessary permissions are achieved in response to the approved RBAC request and the updated at least one RBAC rule; and activate at least one of the plurality of application workloads that has a failure based on the updated at least one RBAC rule.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an example of an audit event of the RBAC server in accordance with aspects of the present invention.

FIG. 4 shows an example of an RBAC request of the RBAC server in accordance with aspects of the present invention.

FIG. 5 shows an example of a server and client architecture of the RBAC server in accordance with aspects of the present invention.

FIG. 6 shows an example of a RBAC request policy and confidential rules of the RBAC server in accordance with aspects of the present invention.

FIG. 7 shows an example of a plurality of policies of an RBAC manual approver module of the RBAC server in accordance with aspects of the present invention.

FIG. 8 shows an example of roles and rolebinding of the RBAC server in accordance with aspects of the present invention.

FIG. 9 shows an example of audit events, roles, and role binding of the RBAC server in accordance with aspects of the present invention.

FIG. 10 shows an example of an application workload job of the RBAC server in accordance with aspects of the present invention.

FIG. 11 shows a flowchart of an exemplary method in accordance with aspects of the present invention.

FIG. 12 shows a flowchart of an exemplary method in accordance with aspects of the present invention.

FIG. 13 shows a flowchart of an exemplary method in accordance with aspects of the present invention.

### DETAILED DESCRIPTION

Aspects of the present invention relate generally to dynamic role based access control (RBAC). Embodiments of the present invention provide an RBAC system, a computer program product, and computer-implemented method which implements the principle of least privilege. Embodiments of the present invention implement the principle of least privilege for applications to grant only a minimum level of access or permissions required to perform application specific tasks and functions which is fundamental to security and access control in computer systems. In particular, aspects of the present invention provide a system, a computer program product, and computer-implemented method to build a RBAC permission model by iteratively detecting and determining a minimum number of necessary permissions. Embodiments of the present invention provide application RBAC settings to progressively increase necessary permissions for applications. Embodiments of the present invention also provide a separate RBAC from business logic development, which is similar to an idea of aspect-oriented programming (AOP) applications in areas such as logging. Further, the separate RBAC is maintained centrally. Aspects of the present invention provide a benefit to customers who are concerned about security.

Embodiments of the present invention also provide an ultimate expected status by running an application with full access. Embodiments of the present invention start from a minimum known access (or zero access), run the application in a same sandbox, record and analyze error messages and audit logs in response to encountering permission issues. Embodiments of the present invention then calculate a next RBAC incremental set according to the principle of least privilege. Embodiments of the present invention re-run the application with the newly added RBAC increment access. In particular, aspects of the present invention iterate the above process until an expected status is achieved.

Embodiments of the present invention include a centrally placed RBAC requester or multiple requesters, which are each bundled with an application to work with an RBAC manager via a secured connection to accept or reject an RBAC request generated based on audit events and controlled by policies. Embodiments of the present invention provide a machine or manual approver controlled by configurable RBAC policy. Further, embodiments of the present invention provide a traceability among audit events for original operations, RBAC request, RBAC rules, and audit events for RBAC rules to create and/or update. Aspects of the present invention include a workload retry activator to activate the workloads which exhaust their maximum number of retries for missing RBAC compensation.

Embodiments of the present invention provide a computer-implemented method, a system, and a computer program product for iteratively detecting and determining minimum necessary permissions to build an RBAC permission model. In contrast, conventional systems merely try to reduce a complexity of role based access control based on existing access roles. However, conventional systems are not able to substantially reduce the complexity of the role based access control or dynamically manage the countless resources and services involved in modern applications. Embodiments of the present invention implement the concept of least privilege to substantially reduce an overall complexity by providing only a minimum level of access or permissions to perform specific tasks and functions within applications. Embodiments of the present invention also provide machine or manual approval to configure RBAC policy and provide traceability among audit events, RBAC requests, RBAC rules, etc. Further, embodiments of the present invention provide a workload retry activator to activate workloads which exhaust a maximum number of retries.

Embodiments of the present invention include a dynamic RBAC system, method, and computer program product for implementing the principle of least privilege, which is necessarily rooted in computer technology. As stated above, the principle of least privilege grants applications a minimum level of access or permissions to implement security and access control for application tasks and functions. Accordingly, implementations of the present invention provide an improvement (i.e., technical solution) to a problem arising in the technical field of providing role-based access controls. In particular, embodiments of the present invention significantly reduce a complexity of RBAC systems by utilizing the principle of least privilege in comparison to conventional systems. Also, embodiments of the present invention may not be performed in the human mind (or with pen and paper) because aspects of the present invention start from zero access control, calculate a next RBAC incremental set according to the principle of least privilege, re-run the application with the newly added RBAC incremental set, and iterate the process until an expected status is achieved. Further, these implementations of the present invention include a RBAC manager which dynamically accepts or rejects RBAC requests generated based on audit events and application workloads and controlled by RBAC policies. In addition, implementations of the present invention dynamically configure the RBAC policies based on application workloads, RBAC requests, and audit events. Also, implementations of the present invention also include a workload retry activator to activate the workloads which exhaust a maximum number of retries. Given the scale and complexity of dynamically calculating a next RBAC incremental set according to the principle of least privilege, re-running the application with the newly added RBAC incremental set, and iterating the process until the expected status is achieved, it is simply not possible for the human mind, or for a person using pen and paper, to calculate a next RBAC incremental set according to the principle of least privilege, re-run the application with the newly added RBAC incremental set, and iterate the process.

Aspects of the present invention include a method, system, and computer program product for generating high quality synthetic metrics data. For example, a computer-implemented method includes: running an application which has a minimum known access in a sandbox; recording and analyzing error messages from audit logs when permission issues occur; calculating and creating a next round of RBAC incremental sets according to a principle of least privilege; running the application with the next round of RBAC incremental sets in place; and iterating the above steps until an expected status is achieved for the application without any failures.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as role based access control code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

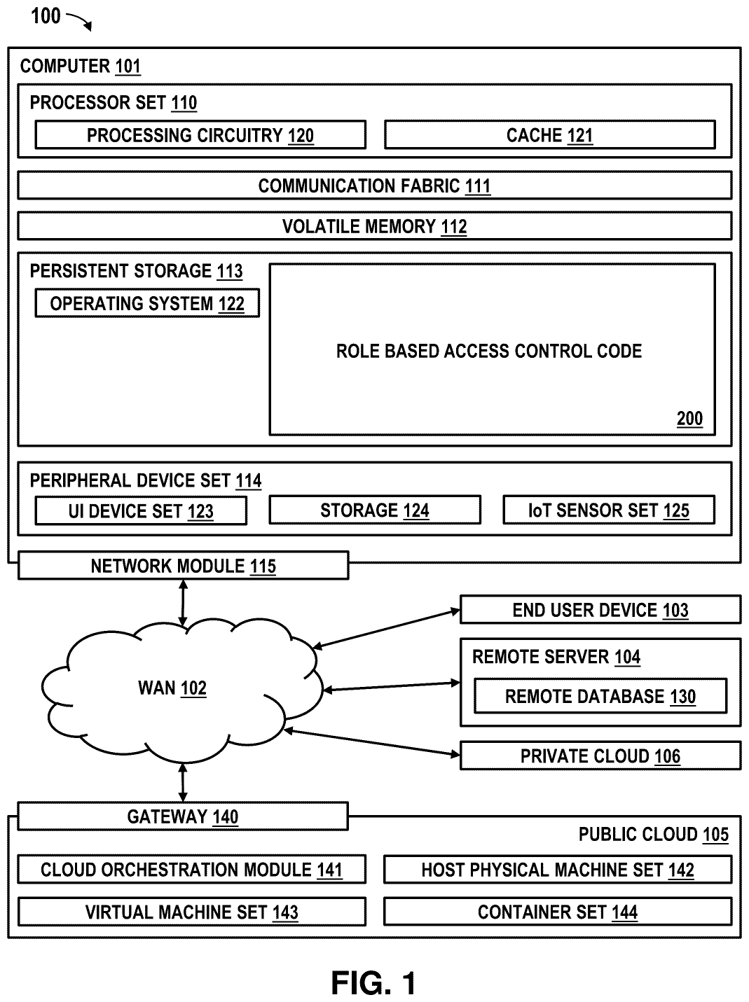

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

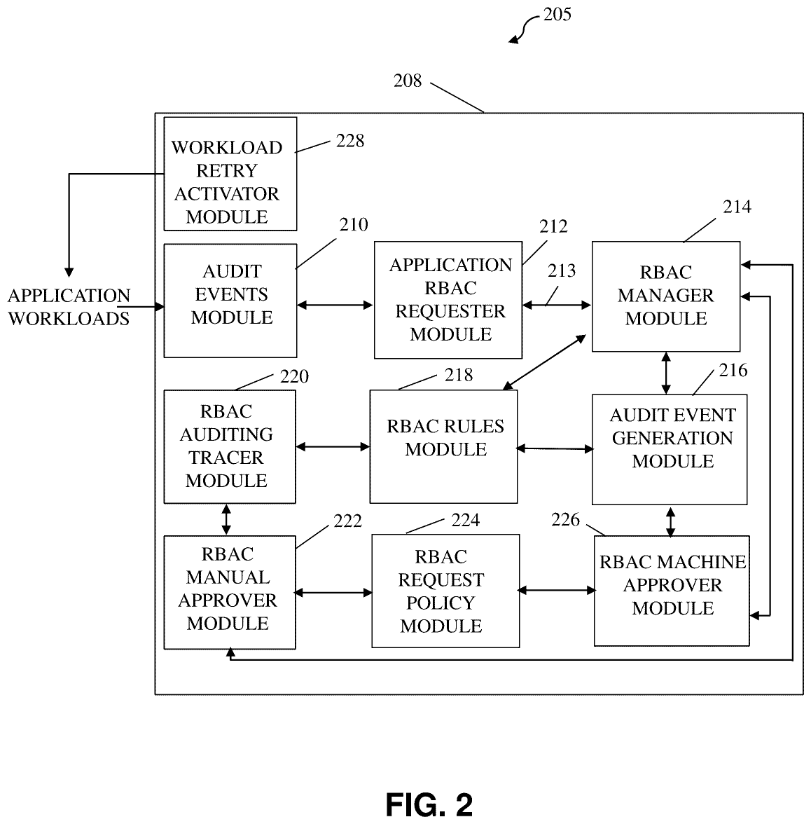

FIG. 2 shows a block diagram of an exemplary environment 205 in accordance with aspects of the present invention. In embodiments, the environment 205 includes a role based access control (RBAC) server 208, which may comprise one or more instances of the computer 101 of FIG. 1. In other examples, the RBAC server 208 comprises one or more virtual machines or one or more containers running on one or more instances of the computer 101 of FIG. 1.

In embodiments, the RBAC server 208 of FIG. 2 comprises an audits events module 210, an application RBAC requestor module 212, a RBAC manager module 214, an audit event generation module 216, a RBAC rules module 218, a RBAC auditing tracer module 220, a RBAC manual approver module 222, a RBAC request policy module 224, a RBAC machine approver module 226, and a workload retry activator module 228, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The RBAC server 208 may include additional or fewer modules than those shown in FIG. 2. For example, the RBAC server 208 of FIG. 2 includes a RBAC request 213 which is generated by the application RBAC requester module 212. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In aspects of the present invention, the RBAC server 208 builds a permission model for an application by iteratively detecting and determining minimum necessary permissions. In particular, the RBAC server 208 builds the permission model by starting from a minimum known access, running the application in a sandbox, recording and analyzing error messages and audit logs that occur when a permission issue is detected, calculating a next RBAC increment set according to a principle of least privilege, re-running the application with the next RBAC increment, and continuing to iterate the above steps until an expected status is achieved and no permission issues are detected. In embodiments, the RBAC server 208 provides a role based access system for at least one application based on a principle of least privilege which iterates a minimum known access level until the at least one application is able to run without any role based access failures.

In accordance with aspects of the present invention, the audit events module 210 receives a plurality of application workloads from an external application. In embodiments, the audit events module 210 receives the plurality application workloads and collects specific data from the application workloads including when a resource was accessed, a resource access URL and an access type, who is accessing the resource, resource details, and an access result. In further embodiments, the audit events module 210 generates an audit event which contains an error message when a permission issue occurs. In an example, the permission issue occurs in response to an access denial message being sent for a specific user who is not able to access an application.

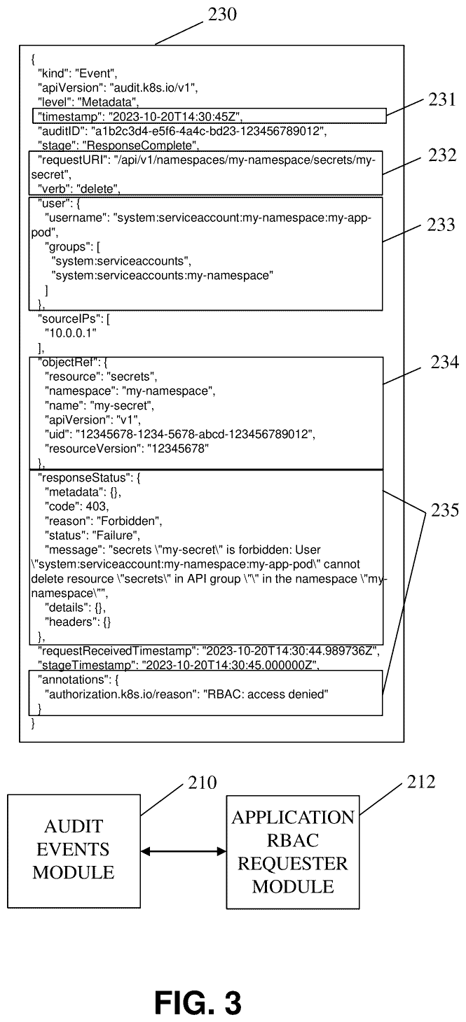

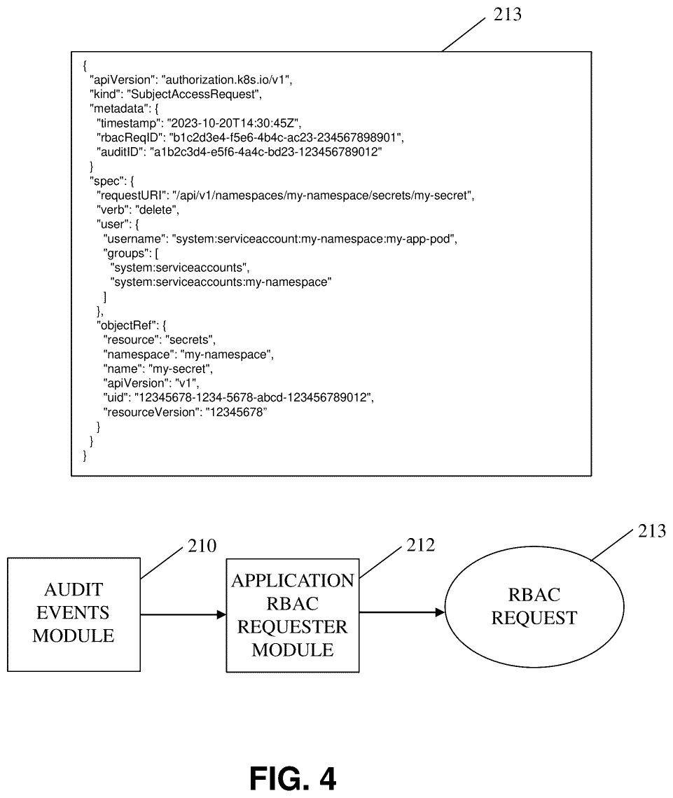

In embodiments, the application RBAC requester module 212 monitors the audit events module 210 for audit events that are failed in response to performing at least one operation of creating, reading, updating, and deleting (CRUD) against resources. For example, the application RBAC requester module 212 generates a RBAC request 213 (see also the RBAC request 213 in FIG. 4) according to the specific data from the audit events module 210 in response to a failure status within the access request (i.e., the access results includes a failure status). The application RBAC requester module 212 sends the generated RBAC request 213 to the RBAC manager module 214. In particular, the specific data from the audit events module 210 includes all of the information needed to generate the RBAC request 213, such as when the CRUD operation happens, which resource is accessed, which type of access is performed, who is accessing the resource, etc. For example, a typical indicator for a failed case is to check the access result in the audit events module 210 for a code 403 in “responseStatus” and “RBAC access denied” in “authorization.k8.io/reason”. In accordance with aspects of the present invention, the RBAC manager module 214 generates the RBAC request 213 based on the information retrieved from the audit events module 210. In another example, the RBAC request 213 indicates that a service account “system:serviceaccount:my-namespace:my-app-pod” was trying to delete a secret “my-secret” in namespect “my namespace”. In embodiments, the application RBAC requester module 212 monitors the audit event from the audit events module 210, determines that there is a failure status within the access request of the audit event, and generates the RBAC request 213 based on information (e.g., a security issue) from the audit event. Details of the audit events module 210, the application RBAC requester module 212, and the RBAC request 213 are described in FIGS. 3 and 4.

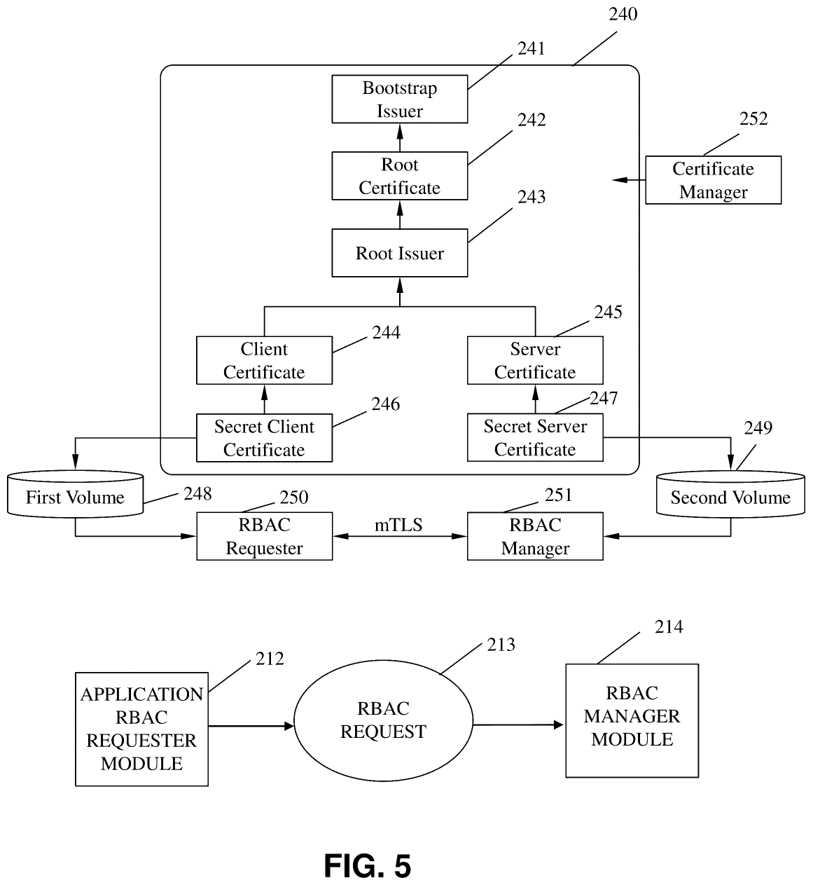

In accordance with aspects of the present invention, the application RBAC requester module 212 and the RBAC manager module 214 are decoupled as separate modules in the RBAC server 208. In embodiments, there can be a single central application RBAC requester module 212 or multiple RBAC application requester modules 212 with each application RBAC requester module 212 bound to an application. In further embodiments, the RBAC manager module 214 has a single global instance. The RBAC manager module 214 comprises a central server serving requests from different clients. Accordingly, the RBAC manager module 214 is protected in a production environment. In particular, the RBAC manager module 214 grants access to any system resource per the RBAC request 213. Thus, a communication between the application RBAC requester module 212 and the RBAC manager module 214 is secured through a secured connection using a method for mutual authentication (mTLS). Details of the secured connection between the application RBAC requester module 212 and the RBAC manager module 214 are described in FIG. 5.

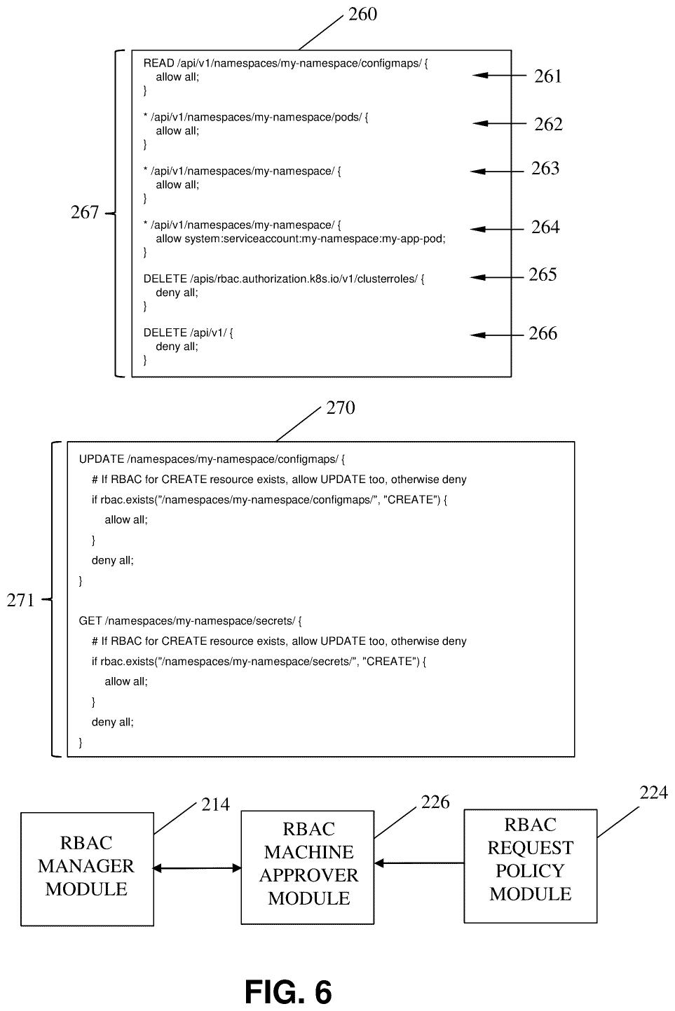

In embodiments of FIG. 2, the RBAC manager module 214 communicates with the RBAC machine approver module 226 to provide an automatic approval or denial in response to the RBAC request 213 being generated due to a security reason in a production environment. In an example, the RBAC manager module 214 communicates with the RBAC machine approver module 226 for automatic approval using predefined policies in a sequential order, such as allowing GET to a same type of resources as the RBAC request 213, allowing the operations against the same type of resources, allowing the operations against the resources in the specific namespace, allowing the operations from a specific user, e.g., a specific service account, denying all operations against a cluster-scoped resources, and denying DELETE to all resources. These policies are combined as a chain and processed one by one to determine whether to allow or deny access for the RBAC request 213. For example, the code snippets for a policy definition may include READ <resourcePath>maps to HTTP GET <resourcePath>. In another example, the code snippets for a policy definition includes an operation “*” which maps to all HTTP verbs. The RBAC machine approver module 226 supports condition rules by introducing calls to utility functions. In further embodiments, the RBAC machine approver module 226 comprises artificial intelligence (AI) technology, such as a machine learning model to receive historical RBAC requests and model approvals or denials based on training of the historical RBAC requests. The RBAC machine approver module 226 then receives the current RBAC request 213 and dynamically approves or denies the current RBAC request 213 based on the machine learning model. The machine learning model of the RBAC machine approver module 226 then incorporates the current RBAC request 213 into the historical RBAC requests to iterate and learn different scenarios for approval and denials of future RBAC requests. In embodiments, the RBAC manager module 214 sends the RBAC request 213 to the RBAC machine approver module 226 for an automatic approval or denial of access based on the RBAC request 213. In further embodiments, the RBAC machine approver module 226 reviews the RBAC request 213 to determine whether the specific user should have had access to the application (e.g., approval of access) or should not have had access to the application (e.g., denial of access). Details of the RBAC machine approver module 226 are described in FIG. 6.

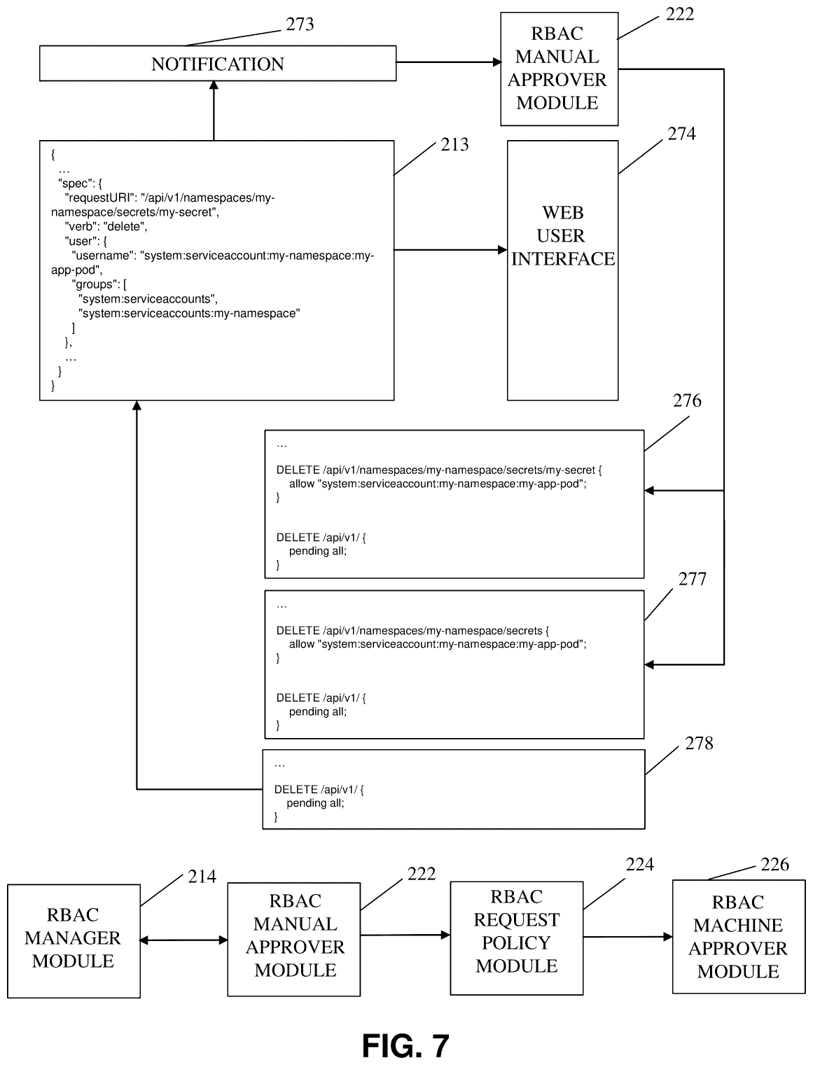

In further embodiments of FIG. 2, the RBAC manager module 214 communicates with the RBAC manual approver module 222 to provide a manual approval or denial based on details of the RBAC request 213. In an example, the RBAC manual approver module 222 communicates with at least one person to provide the manual approval or denial based on the details of the RBAC request 213. In further embodiments, the RBAC manual approver module 222 comprises the at least one person to add a new RBAC policy, modify an existing RBAC policy, or remove the existing RBAC policy during runtime. For example, in response to the RBAC manual approver module 222 comprising the at least one person allowing or denying access to a specific resource, the at least one person of the RBAC manual approver module 222 is subsequently asked whether to apply the same policy to a same type of resource in future RBAC requests. In aspects of the present invention, a new directive of “pending” is included in a RBAC policy definition to trigger manual approval. As an example, a RBAC policy can define a new directive of “pending” so that all delete operations require manual review and approval. The RBAC manual approver module 222 uses predefined policies in a sequential order, such as all DELETEs needing manual approval by default, allowing a DELETE by a specified user, allowing DELETEs of all secrets by the specified user, and adding a new policy and removing an old policy based on approving or rejecting the current RBAC request 213 such that manual approval is not needed for a future RBAC request which is the same as the current RBAC request 213. In embodiments, the RBAC manager module 214 sends the RBAC request 213 to the RBAC manual approver module 222 for an approval or denial of access by at least one person based on the RBAC request 213. In further embodiments, the RBAC manual approver module 222 reviews the RBAC request 213 to determine whether the specific user should have had access to the application (e.g., approval of access) or should not have had access to the application (e.g., denial of access). Details of the RBAC manual approver module 222 are described in FIG. 7.

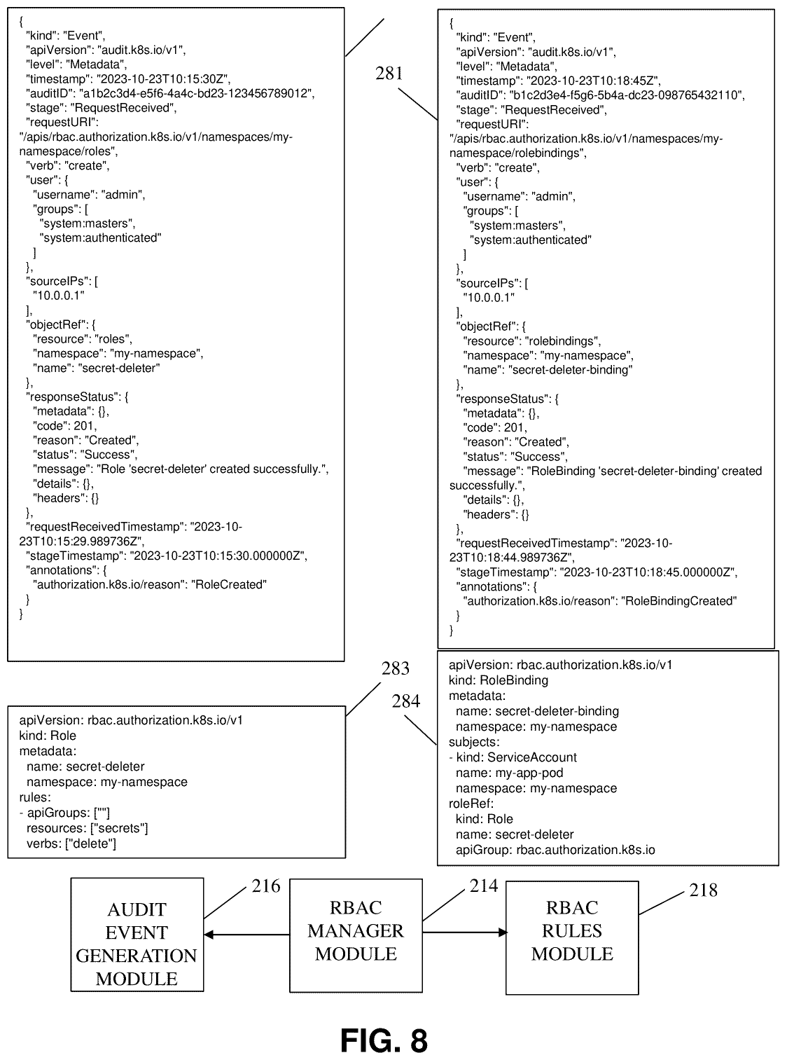

In aspects of the present invention, the RBAC manager module 214 creates or updates RBAC rules in the RBAC rules module 218 once the RBAC request 213 is approved or denied. Further, the RBAC manager module 214 also generates an audit event in the audit event generation module 216 for the created or updated RBAC rules. Accordingly, the audit event generation module 216 includes audit events so that behavior is auditable for a security reason. For example, the RBAC manager module 214 defines a role for required permissions by “my-app-pod” in the “my-namespace” namespace. In this scenario, the RBAC manager module 214 allows deletion of secrets. In another example, the RBAC manager module 214 includes a code snippet which defines a rolebinding which binds the role to the ServiceAccount of “my-app-pod. In this scenario, the RBAC manager module 214 associates the permissions defined in the role with the specified pod. In embodiments, the RBAC manager module 214 creates or updates RBAC rules in response to the RBAC request 213 being approved or denied. For example, the RBAC manager module 214 creates an RBAC rule to approve future access to the application for the specific user in response to the RBAC request being approved in a current access. Details of the RBAC manager module 214 are described in FIG. 8.

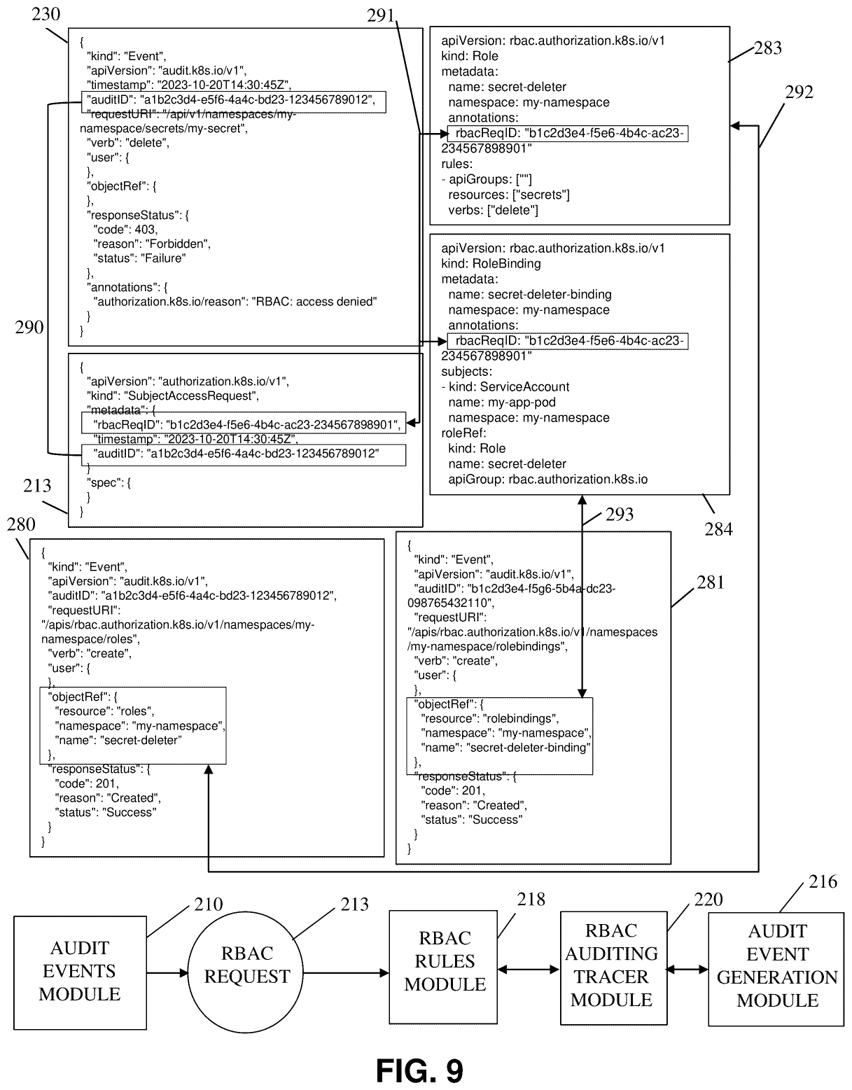

In embodiments of FIG. 2, the RBAC auditing tracer module 220 provides traceability of the RBAC auditing in response to the manual approval or machine approval of the RBAC request 213. For example, the RBAC auditing tracer module 220 traces the RBAC auditing based on a correlation between the audit event triggering the RBAC request 213, the RBAC request 213, the RBAC rules, and the audit events for the created or updated RBAC rules. In further embodiments, the RBAC auditing tracer module 220 provides traceability of the RBAC auditing to analyze RBAC manipulation and changes throughout the RBAC server 208. The RBAC auditing tracer module 220 provides traceability of the audit events of the manual approval, the machine approval, and the created or updated RBAC rules. Details of the RBAC auditing tracer module 220 are described in FIG. 9.

In aspects of the present invention, the RBAC manager module 214 of the RBAC server 208 determines whether the minimum necessary permissions are achieved. In embodiments, the RBAC server 208 determines that the minimum necessary permissions are achieved in response to no failed application workloads. In response to the RBAC server 208 determining that the minimum necessary permissions are achieved, the RBAC server 208 determines that the expected status of a least privileged system is achieved. In response to the RBAC server 208 determining that the minimum necessary permissions are not achieved, the RBAC server 208 iterates all of the previous steps in FIG. 2 until the expected status is achieved. In further embodiments, the workload retry activator module 228 of the RBAC server 208 re-runs the application workloads in response to determining that the minimum necessary permissions are achieved.

In aspects of the present invention, the workload retry activator module 228 activates failed application workloads. In an example, the workload retry activator module 228 activates a failed application in response to a maximum number of retries being reached. In this scenario, the workload retry activator module 228 helps to restart the failed application quicker than would normally happen by the RBAC manual approver module 222 and the RBAC machine approver module 226. For example, the workload retry activator 228 activates a Kubernetes job that is failed due to a workload status of “BackoffLimitExceeded”. In particular, the workload retry activator 228 checks a workload status (e.g., a job status field with a failed condition including a reason “BackoffLimitExceeded”) and then determines whether at least one application workload job needs activation based on a value of the workload status (e.g., “BackoffLimitExceeded” will indicate that the application workload job needs activation). The application workloads in the RBAC server 208 support a retry mechanism that may reach a maximum number of retries and then fail after the maximum number of retries is reached. The application workloads reaching the maximum number of retries and then failing are caused by many reasons, including a reason that the RBAC manual approver module 222 takes longer time to approve than expected. For example, in a Kubernetes system, an application workload job is configured to have a maximum number of retries. In this situation, when the application workload job fails, a job controller automatically restarts a pod until the maximum number of retries is reached. The job controller outputs a failure indication to the workload status (e.g., “BackoffLimitExceeded”) in response to the maximum number of retries being reached. Accordingly, the application workload job won't automatically restart the pod in response to the workload status having the failure indication (e.g., “BackoffLimitExceeded”). In this scenario, the workload retry activator 228 provides activation of failed application workloads. Also, the workload retry activator 228 checks a user or a service account corresponding to a new RBAC rule or an updated existing RBAC rule and the application workload the references the user or the service account in response to the new RBAC rule being created or the existing RBAC rule being updated. In this situation, the workload retry activator 228 activates the application workload job by deleting the application workload job and re-creating the application workload job in response to the application workload job failing due to “BackoffLimitExceeded”. Further, in embodiments, the workload retry activator 228 activates the application workload job (i.e., by re-creating the application workload job) with the new RBAC rule or the updated existing RBAC rule.

FIG. 3 shows an example of an audit event of the RBAC server 208 in accordance with aspects of the present invention. As described above with reference to FIG. 2, the application RBAC requester module 212 monitors the audit events module 210 for audit events that are failed in response to performing at least one operation of creating, reading, updating, and deleting (CRUD) against resources. In an example, the audit events module 210 generates an audit event 230 which includes specific data such as when a resource was accessed 231, a resource access URL and an access type 232, who is accessing the resource 233, resource details 234, and an access result 235. In the example of FIG. 3, the access result 235 comprises a code and the reason for “response status” (i.e., “403 Forbidden”) and an authorization reason for “authorization.k8.io/reason” (i.e., “RBAC: access denied”).

FIG. 4 shows an example of an RBAC request of the RBAC server 208 in accordance with aspects of the present invention. As described above with reference to FIG. 2, the application RBAC requester module 212 generates the RBAC request 213 based on a plurality of application workloads received by the audit events module 210. Further, in the example of FIG. 4, the RBAC request 213 indicates that the service account “system: serviceaccount:my-namespace:my-app-pod”was trying to delete a secret “my-secret” in namespace “my namespace”.

FIG. 5 shows an example of a server and client architecture of the RBAC server 208 in accordance with aspects of the present invention. In FIG. 5, a server and client architecture 240 includes a bootstrap issuer 241, a root certificate 242, a root issuer 243, a client certificate 244, a server certificate 245, a secret client certificate 246, and a secret server certificate 247. Further, the RBAC server 208 comprises a first volume 248, a second volume 249, and a certificate manager 252. The application RBAC requester module 212 comprises a RBAC requester 250 and the RBAC manager module 214 comprises a RBAC manager 251. In the server and client architecture 240, traffic between a client (e.g., the client certificate 244, the secret client certificate 246, etc.) and a server (e.g., the server certificate 245, the secret server certificate 247, etc.) is encrypted. Further, both the client and the server use certificates signed by the certificate manager 252 through the root issuer 243, the root certificate 242, and the bootstrap issuer 241. Accordingly, both the client and the server authenticate each other and are assured of each other's identity. As described above with reference to FIG. 2, the RBAC requester 250 has a secured connection with the RBAC manager 251 by using mTLS.

FIG. 6 shows an example of a RBAC request policy and confidential rules of the RBAC server 208 in accordance with aspects of the present invention. In the example of FIG. 6, a RBAC request policy 260 includes a first policy of allowing GET to the same type of resources 261, a second policy of allowing the operations against the same type of resources 262, a third policy of allowing the operations against resources in the specific namespace 263, a fourth policy of allowing the operations from a specific user, e.g., a specific service account, a fifth policy of denying all operations against the cluster-scoped resources, and a sixth policy of denying DELETE to all resources. These policies are combined as a chain 267 when determining whether to allow or deny access and are processed one by one in appearance order. Further, in the example of FIG. 6, the RBAC server 208 includes conditional rules 270 which include calls to utility functions 271.

FIG. 7 shows an example of a plurality of policies of an RBAC manual approver module of the RBAC server 208 in accordance with aspects of the present invention. In the example of FIG. 7, the RBAC server 208 (e.g., the RBAC manual approver module 222) sends a current policy of all DELETEs needing manual approval by default 278 to the RBAC request 213. In embodiments, the RBAC request 213 needs manual approval by the RBAC manual approver module 222. In embodiments, the RBAC manager module 214 communicates the RBAC request 213 with the RBAC manual approver module 222 by sending a notification 273 to the RBAC manual approver module 222. In embodiments, the notification 273 is one of an online message, SMS, email, etc. In further embodiments, the RBAC manager module 214 communicates the RBAC request 213 with the RBAC manual approver module 222 via a web user interface (UI). The RBAC manual approver module 222 includes at least one person for approving or denying the RBAC request 213. In response to the RBAC manual approver module 222 including the at least one person approving or denying the RBAC request 213, the RBAC manual approver module 222 removes an old policy and adds a new policy so that a similar or same future RBAC request does not need manual approval. In this scenario, the new policy will automatically approve or deny the similar or same future RBAC request using the RBAC machine approver module 226. As an example, the RBAC manual approver module 222 adds a first new policy of allowing to delete a secret by a specified user 276 and a second new policy of allowing to delete all secrets by a specified user 277.

FIG. 8 shows an example of roles and rolebinding of the RBAC server 208 in accordance with aspects of the present invention. In the example of FIG. 8, the RBAC manager module 214 generates a first audit event for the role creation 280 and a second audit event for a rolebinding creation 281 and sends the first audit event for the role creation 280 and the second audit event for a rolebinding creation 281 to the audit event generation module 216. The RBAC manager 214 creates a role 283 that defines permissions required by “my-app-pod” in the “my-namespace” namespace. In this scenario, the role 283 also allows the deletion of secrets. The RBAC manager 214 creates a rolebinding 284 that binds the role 283 to the ServiceAccount of “my-app-pod”. Accordingly, the rolebinding 284 associates the permission defined in the role 283 with a specific pod.

FIG. 9 shows an example of audit events, roles, and rolebinding of the RBAC server 208 in accordance with aspects of the present invention. In the example of FIG. 9, the auditID 290 correlates the audit event 230 with the RBAC request 213. Further, in the example of FIG. 9, the rbacReqID 291 correlates the RBAC request 213 with the role 283 and the rolebinding 284. In further embodiments, the objectRef of the role creation 280 is correlated 292 with the role 283 and the objectRef of the rolebinding creation 281 is correlated 293 with the rolebinding 284.

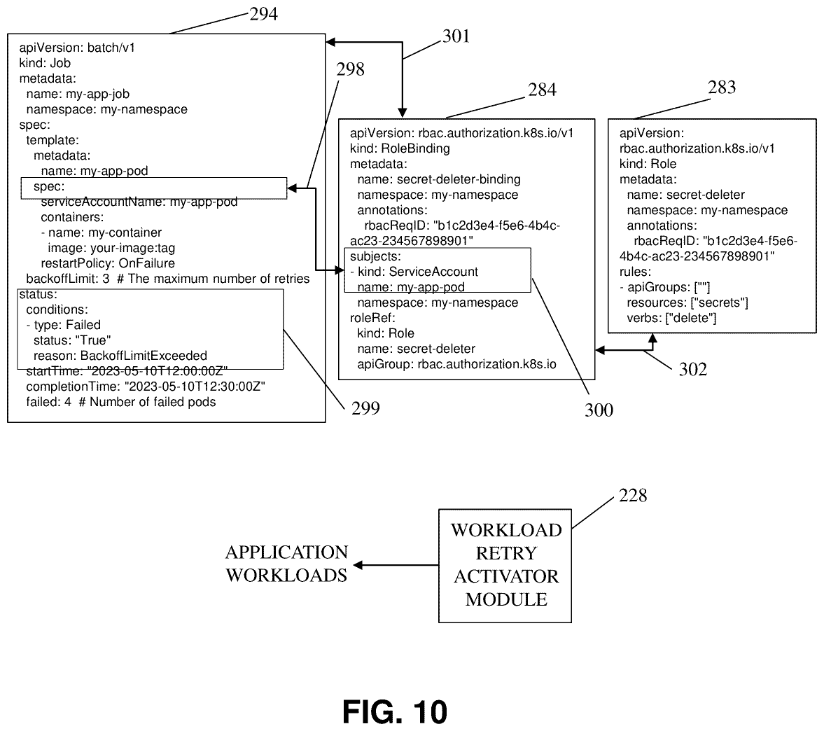

FIG. 10 shows an example of an application workload job of the RBAC server 208 in accordance with aspects of the present invention. In the example of FIG. 10, an application workload job 294 that includes a job status field 299 with a failed condition including a reason “BackoffLimitExceeded”. In embodiments, the application workload job 294 is correlated 298 with a ServiceAccount with a name “my-app-pod” 300. In this scenario, the application workload job 294 is correlated 301 with the rolebinding 284 thru the ServiceAccount with the name “my-app-pod” 300. In further embodiments, the rolebinding 284 is correlated 302 with the role 283.

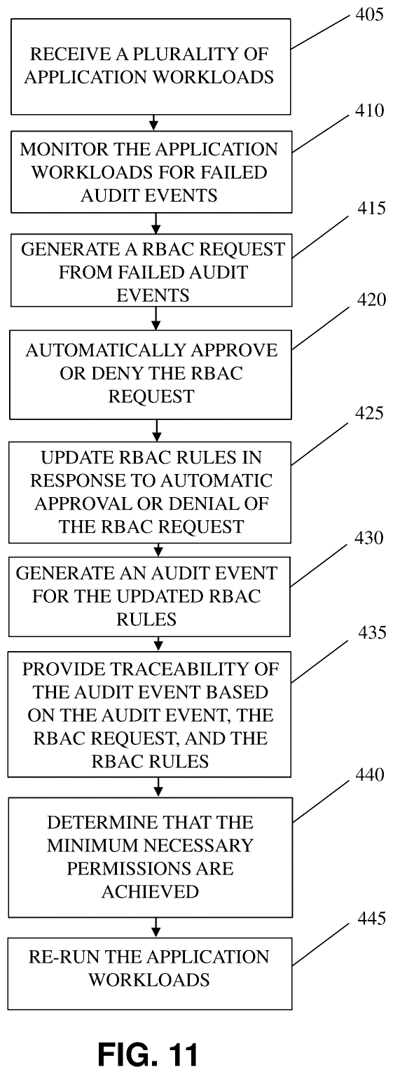

FIG. 11 shows a flowchart of an exemplary method in accordance with aspects of the present invention. Steps of the method may be carried out in the environment of FIG. 2 and are described with reference to elements depicted in FIG. 2.

At step 405, the system receives, at the audit events module 210, a plurality of application workloads. In embodiments and as described with FIG. 2, the audit events module 210 collects specific data from the application workloads including when a resource was accessed, a resource access URL and an access type, who is accessing the resource, resource details, and an access result. At step 410, the system monitors, at the application RBAC requester module 212, the audit events module 210 for audit events of the application workloads that are failed in response to performing at least one operation of creating, reading, updating, and deleting (CRUD) against resources.

At step 415, the system generates, at the application RBAC requester module 212, a RBAC request for the failed audit events. Also, in embodiments and as described with FIG. 2, the application RBAC requester module 212 sends the RBAC request to the RBAC manager module 214. At step 420, the system provides, at the RBAC machine approver module 226, an automatic approval or denial of the RBAC request in response to the RBAC request being generated. At step 425, the system updates, at the RBAC rules module 218, RBAC rules in response to the automatic approval or denial of the RBAC request.

At step 430, the system generates, at the audit event generation module 216, an audit event for the updated RBAC rules. At step 435, the system provides, at the RBAC auditing tracer module 220, a traceability of the audit event based on the audit event, the RBAC request, and the updated RBAC rules. At step 440, the system determines, at the RBAC server 208, that the minimum necessary permissions are achieved. In embodiments and as described with respect to FIG. 2, the system determines that the minimum necessary permissions are achieved when there are no failed application workloads. At step 445, the system re-runs, at the RBAC server 208, the application workloads in response to a determination that the minimum necessary permissions are achieved.

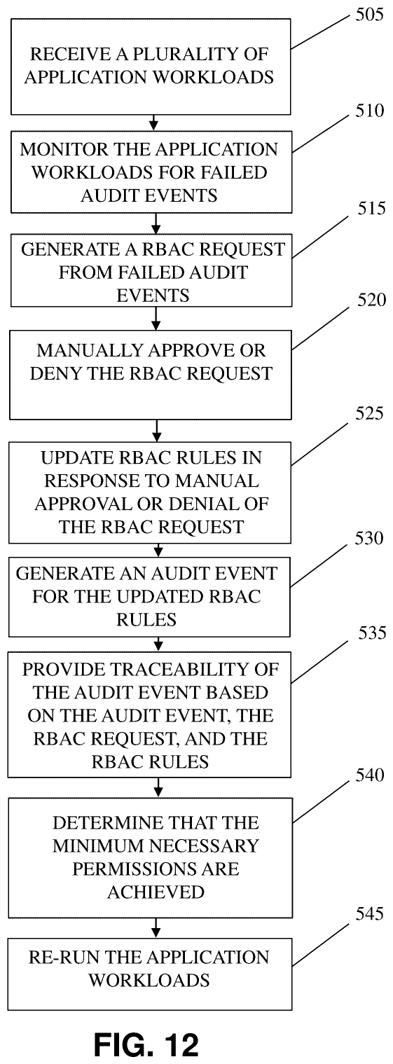

FIG. 12 shows a flowchart of an exemplary method in accordance with aspects of the present invention. Steps of the method may be carried out in the environment of FIG. 2 and are described with reference to elements depicted in FIG. 2.

At step 505, the system receives, at the audit events module 210, a plurality of application workloads. In embodiments and as described with FIG. 2, the audit events module 210 collects specific data from the application workloads including when a resource was accessed, a resource access URL and an access type, who is accessing the resource, resource details, and an access result. At step 510, the system monitors, at the application RBAC requester module 212, the audit events module 210 for audit events of the application workloads that are failed in response to performing at least one operation of creating, reading, updating, and deleting (CRUD) against resources.

At step 515, the system generates, at the application RBAC requester module 212, a RBAC request from the failed audit events. Also, in embodiments and as described with FIG. 2, the application RBAC requester module 212 sends the RBAC request to the RBAC manager module 214. At step 520, the system provides, at the RBAC manual approver module 222, a manual approval or denial of the RBAC request by at least one person in response to the RBAC request being generated. At step 525, the system updates, at the RBAC rules module 218, RBAC rules in response to the manual approval or denial of the RBAC request.

At step 530, the system generates, at the audit event generation module 216, an audit event for the updated RBAC rules. At step 535, the system provides, at the RBAC auditing tracer module 220, a traceability of the audit event based on the audit event, the RBAC request, and the updated RBAC rules. At step 540, the system determines, at the RBAC server 208, that the minimum necessary permissions are achieved. In embodiments and as described with respect to FIG. 2, the system determines that the minimum necessary permissions are achieved when there are no failed application workloads. At step 545, the system re-runs, at the RBAC server 208, the application workloads in response to a determination that the minimum necessary permissions are achieved.

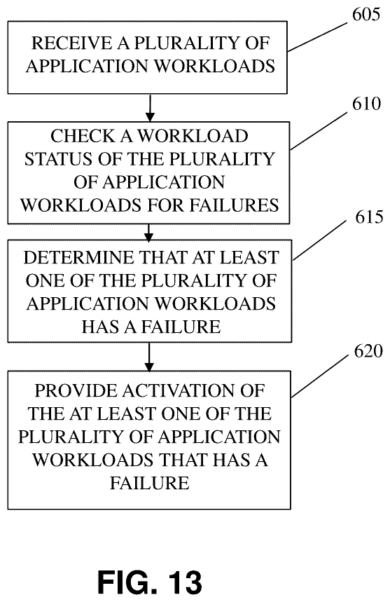

FIG. 13 shows a flowchart of an exemplary method in accordance with aspects of the present invention. Steps of the method may be carried out in the environment of FIG. 2 and are described with reference to elements depicted in FIG. 2.

At step 605, the system receives, at the workload retry activator module 226, a plurality of application workloads. At step 610, the system checks, at the workload retry activator module 226, a workload status of the plurality of application workloads for failures.

At step 615, the system determines, at the workload retry activator module 226, that at least one of the plurality of application workloads has a failure. At step 620, the system provides, at the workload retry activator module 226, activation of the at least one of the plurality of application workloads that has a failure.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a plurality of application workloads from an external application;
monitoring, by the processor set, the plurality of application workloads for at least one failed audit event;
generating, by the processor set, a role based access control (RBAC) request from the at least one failed audit event;
updating, by the processor set, at least one RBAC rule based on the RBAC request;
determining, by the processor set, that minimum necessary permissions are achieved in response to the RBAC request and the updated at least one RBAC rule; and
re-running, by the processor set, the application workloads in response to a determination that the minimum necessary permissions are achieved.

2. The computer-implemented method of claim 1, further comprising:
approving, by the processor set, the RBAC request; and
generating, by the processor set, an audit event for the updated at least one RBAC rule.

3. The computer-implemented method of claim 2, further comprising providing, by the processor set, traceability of the audit event based on the audit event, the RBAC request, and the updated at least one RBAC rule.

4. The computer-implemented method of claim 2, further comprising:
receiving, by the processor set, historical RBAC requests from the external application; and
training, by the processor set, a machine learning model based on the received historical RBAC requests.

5. The computer-implemented method of claim 4, wherein the approving the RBAC request is based on the trained machine learning model.

6. The computer-implemented method of claim 1, further comprising checking, by the processor set, a workload status of the plurality of application workloads for at least one failure.

7. The computer-implemented method of claim 6, further comprising determining, by the processor set, that at least one of the plurality of application workloads has a failure based on the workload status of the plurality of application workloads.

8. The computer-implemented method of claim 7, further comprising activating, by the processor set, the at least one of the plurality of application workloads that has the failure.

9. The computer-implemented method of claim 8, wherein the activating the at least one of the plurality of application workloads that has the failure is based on the updated at least one RBAC rule.

10. The computer-implemented method of claim 1, wherein the determining that the minimum necessary permissions are achieved occurs in response to the plurality of application workloads having no failed workloads.

11. The computer-implemented method of claim 1, further comprising collecting, by the processor set, specific data from the plurality of application workloads including when a resource was accessed, a resource access uniform resource locator (URL) and an access type, who is accessing the resource, resource details, and an access result.

12. A computer program product comprising one or more computer readable storage media having program instructions collectively stored on the one or more computer readable storage media, the program instructions executable to:
receive a plurality of application workloads from an external application;
monitor the plurality of application workloads for at least one failed audit event;
generate a role based access control (RBAC) request from the at least one failed audit event;
approve the RBAC request based on a machine learning model which is trained based on historical RBAC requests from the external application;
update at least one RBAC rule in response to automatically approving of the RBAC request;
determine that minimum necessary permissions are achieved in response to the approved RBAC request and the updated at least one RBAC rule; and
re-run the application workloads in response to a determination that the minimum necessary permissions are achieved.

13. The computer program product of claim 12, wherein the program instructions are further executable to generate an audit event for the updated at least one RBAC rule.

14. The computer program product of claim 13, wherein the program instructions are further executable to provide traceability of the audit event based on the audit event, the RBAC request, and the updated at least one RBAC rule.

15. The computer program product of claim 12, wherein the program instructions are further executable to:
receive the historical RBAC requests from the external application; and
train the machine learning model based on the received historical RBAC requests.

16. The computer program product of claim 12, wherein the program instructions are further executable to check a workload status of the plurality of application workloads for at least one failure.

17. The computer program product of claim 16, wherein the program instructions are further executable to determine that at least one of the plurality of application workloads has a failure based on the workload status of the plurality of application workloads.

18. The computer program product of claim 17, wherein the program instructions are further executable to activate the at least one of the plurality of application workloads that has the failure.

19. The computer program product of claim 18, wherein the activating the at least one of the plurality of application workloads that has the failure is based on the updated at least one RBAC rule.

20. A system comprising:
a processor set, one or more computer readable storage media, and program instructions collectively stored on the one or more computer readable storage media, the program instructions executable to:
receive a plurality of application workloads and a plurality of historical role based access control (RBAC) requests from an external application;
monitor the plurality of application workloads for at least one failed audit event;
generate a RBAC request from the at least one failed audit event;
train a machine learning model based on the received historical RBAC requests;
approve the RBAC request based on the trained machine learning model;
update at least one RBAC rule in response to automatically approving of the RBAC request;
determine that minimum necessary permissions are achieved in response to the approved RBAC request and the updated at least one RBAC rule; and
activate at least one of the plurality of application workloads that has a failure based on the updated at least one RBAC rule.
